(19) United States
(12) Patent Application Publication
(10) Pub. No.: US 2019/0173604 A1
(43) Pub. Date: Jun. 6, 2019

(54) HIGH-SPEED OPTICAL TRANSCEIVER BASED ON CWDM AND SDM

(71) Applicant: Alibaba Group Holding Limited, George Town (KY)

(72) Inventor: Chongjin Xie, Morganville, NJ (US)

(73) Assignee: Alibaba Group Holding Limited, George Town (KY)

(21) Appl. No.: 15/831,228

(22) Filed: Dec. 4, 2017

(51) Int. Cl. H04J 14/04; H04J 14/02; H04B 10/40; H04B 10/50; H04Q 11/00

(52) U.S. Cl. CPC H04J 14/04; H04J 14/0212; H04B 10/40; H04B 10/503; H04Q 2011/0016; H04J 14/026; H04Q 11/0005; H04Q 11/0062; H04J 14/0209

(57) ABSTRACT

One embodiment of the present invention provides an optical transceiver. The transceiver can include a transmitter and a receiver. Each of the transmitter and receiver can include a plurality of space-division multiplexing (SDM) channels configured to transmit or receive spatially separated optical signals. A respective SDM channel can include a plurality of wavelength channels and an optical wavelength multiplexer or demultiplexer configured to multiplex or demultiplex optical signals to or from the plurality of wavelength channels.

### BACKGROUND

### Field

The present application relates to high-speed optical transceivers. More specifically, the present application relates to high-speed optical transceivers constructed based on coarse wavelength-division multiplexing (CWDM) and space-division multiplexing (SDM) technologies.

### Related Art

In datacenters, a massive number of servers are connected together via data center networks such that they work in concert to provide computing and storage power for Internet services and cloud computing.

FIG. 1 illustrates the exemplary architecture of a datacenter network (prior art). More specifically, FIG. 1 shows the interconnections among the servers, switches (e.g., core switches, aggregate switches, and edge switches), and routers. At low speeds, the switches and servers in the datacenter can be connected using copper cables. However, the copper cables can no longer meet the interconnect requirement, as the speed and size of the network increase.

Since the beginning of this century, the increasing demand of the Internet and cloud computing services has caused datacenter traffic to double every one or two years, presenting a big challenge to datacenter networks. To meet the demand of such fast traffic growth, the speed of datacenter networks has evolved quickly. FIG. 2 shows the evolution of the speed of the servers and switch ports. From 2010 to the present, the speed of the servers and switch ports has evolved from 10 gigabit per second (Gbps) and 40 Gbps to 25 Gbps and 100 Gbps, respectively. Moreover, the speed of the servers and switch ports are projected to reach 100 Gbps and 400 Gbps in 2020, and 400 Gbps and 1.6 terabit per second (Tbps) in 2025, respectively.

In today's high-speed, large-capacity datacenters, optical interconnect has replaced copper cables in almost every connection outside of servers, providing high-bandwidth channels between the connected network devices (e.g., between a server and an edge switch, or between a router and a core switch). The implementation of the optical interconnect makes optical transceivers essential in datacenters. More specifically, at the interface between an electrical switch and the optical interconnect, optical transceivers are used to convert the outgoing electrical signals from the electrical domain to the optical domain and the incoming optical signals from the optical domain to the electrical domain. Optical transceivers operating at the speed of 100 Gbps have been deployed in today's datacenters, and 400 Gbps optical transceivers are being developed. Faster (e.g., 1.6 Tbps and beyond) optical transceivers will soon be needed in datacenters.

### SUMMARY

One embodiment of the present invention provides an optical transceiver. The transceiver can include a transmitter and a receiver. Each of the transmitter and receiver can include a plurality of space-division multiplexing (SDM) channels configured to transmit or receive spatially separated optical signals. A respective SDM channel can include a plurality of wavelength channels and an optical wavelength multiplexer or demultiplexer configured to multiplex or demultiplex optical signals to or from the plurality of wavelength channels.

In a variation on this embodiment, the spatially separated optical signals can include optical signals carried by separate optical fibers.

In a further variation, the separate optical fibers form a multi-fiber optical cable, and the optical transceiver comprises a multi-fiber push-on/push-off connector coupled to the multi-fiber optical cable.

In a variation on this embodiment, the spatially separated optical signals can include optical signals carried by one or more SDM fibers, and the high-speed optical transceiver can include a spatial mode multiplexer and a spatial mode demultiplexer configured to multiplex and demultiplex, respectively, the spatially separated optical signals.

In a further variation, the SDM fibers can include one or more of: a multi-core fiber (MCF) and a multi-mode fiber (MMF).

In a variation on this embodiment, each of the transmitter or receiver can include at least four SDM channels, and each SDM channel can include at least four wavelength channels.

In a further variation, each wavelength channel can have a data rate of at least 100 gigabit per second (Gbps), thereby resulting in the optical transceiver having a data rate of at least 1.6 terabit per second (Tbps).

### BRIEF DESCRIPTION OF THE FIGURES

FIG. 1 illustrates the exemplary architecture of a datacenter network.

FIG. 2 shows the evolution of the speed of the servers and switch ports.

FIG. 3 shows the cross sections of different types of fibers.

FIG. 4 shows a schematic of an exemplary high-speed optical transceiver, according to one embodiment.

FIG. 5A shows an exemplary surface-coupled spatial mode multiplexer, according to one embodiment.

FIG. 5B shows an exemplary edge-coupled spatial mode multiplexer, according to one embodiment.

FIG. 5C shows an exemplary multi-stage waveguide mode multiplexer, according to one embodiment.

FIG. 6 shows a schematic of an alternative exemplary high-speed optical transceiver, according to one embodiment.

FIG. 7 shows a schematic of a high-speed optical transceiver based on multiple fibers, according to one embodiment.

FIG. 8A shows the layout of an MPO-8 connector.

FIG. 8B shows the layout of an MPO-12 connector.

FIG. 9 shows a schematic of a high-speed optical transceiver based on multiple fibers, according to one embodiment.

FIG. 10A presents a flow chart illustrating an exemplary process for transmitting data at a speed of at least 1.6 Tbps, according to one embodiment.

FIG. 10B presents a flow chart illustrating an exemplary process for receiving data at a speed of at least 1.6 Tbps, according to one embodiment.

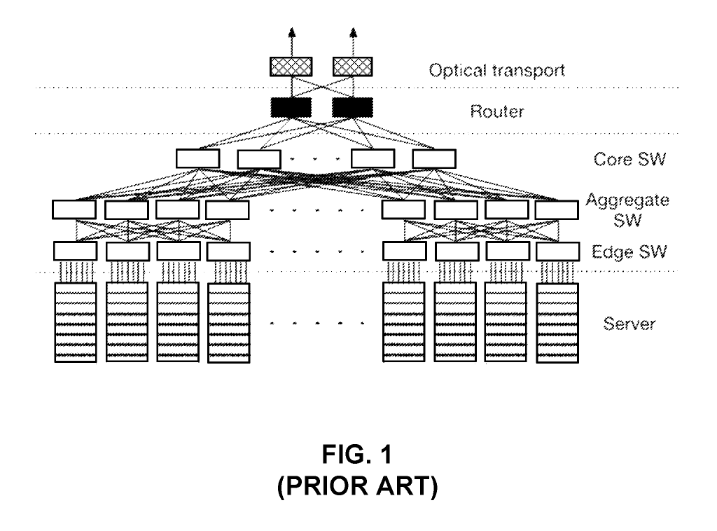

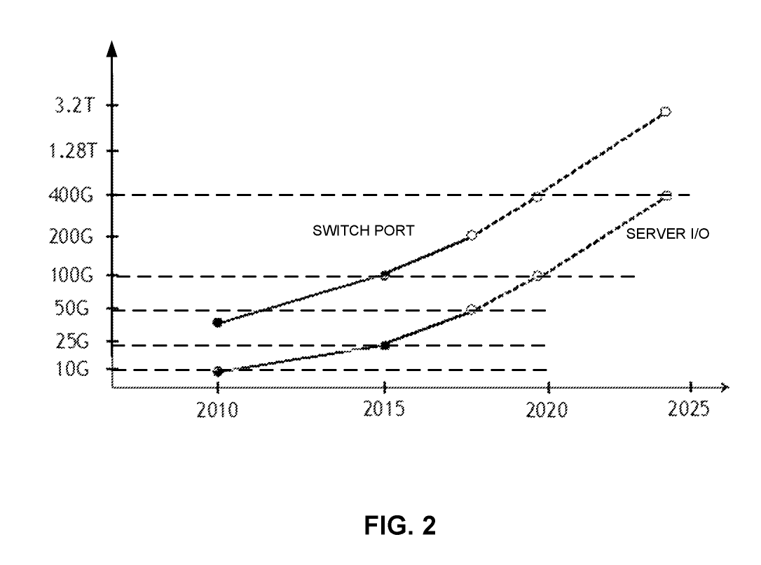

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide an optical transceiver that can operate at a speed of 1.6 Tbps or higher. The optical transceiver combines both the coarse wavelength-division multiplexing (CWDM) technology and the space-division multiplexing (SDM) technology. More specifically, the optical transceiver can include 16 parallel optical lanes, each having a speed of at least 100 Gbps. Various combinations of CWDM and SDM channels can be used to achieve the 16 lanes. In some embodiments, at least four SDM lanes can be established, with each SDM lane accommodating at least four CWDM lanes. The multiple SDM lanes can be achieved using multiple spatial modes in a multi-core fiber (MCF) or a multi-mode fiber (MMF), multiple fibers (e.g., multiple single-mode fibers (SMFs), and multi-fiber push-on/push-off (MPO) cables.

### High-Speed Optical Transceivers

Achieving optical transceivers operating at a speed of 1.6 Tbps or higher can be challenging using today's technologies. One possible approach is to use CWDM technologies. More specifically, the high-speed transceiver can have four wavelength channels, with a channel spacing of 20 nm and each channel running at a speed of 400 Gbps (or 400G) or higher. Note that CWDM4 has been implemented to achieve 100G optical interfaces currently available for datacenter applications. These 100G optical interfaces can include 4 lanes of 25 Gbps optically multiplexed onto a single mode fiber. However, increasing the data rate for each lane (or wavelength channel) from 25 Gbps to 400 Gbps can be challenging. More specifically, the bandwidth requirement for the optical chips as well as the electrical chips in the transceiver can be extremely high. For example, to achieve a speed of 400 Gbps using four-level pulse-amplitude-modulation (PAM4), the bandwidth of the electrical and optical chips needs to be greater than 120 GHz. Such a large bandwidth can be technically difficult to achieve, especially when direct modulated lasers (DMLs) are used.

To relax the bandwidth requirement on the electrical and optical components, one can reduce the speed per wavelength channel while increasing the number of wavelength channels. For example, a transceiver can include 16 or eight WDM channels, with a channel spacing of less than 20 nm (e.g., 10 nm or below). To achieve a bit rate of 1.6 Tbps, each channel needs to have a speed of 100 Gbps or 200 Gbps, respectively. DWDM (dense wavelength division multiplexing) can enable a higher number of channels with 50 GHz or 100 GHz channel spacing, thus allowing each channel to run at a lower data rate. However, the narrower channel spacing requires temperature control of the lasers, which can significantly increase the manufacturing cost and power consumption. An alternative approach is to use multiple fibers. However, the increased number of fibers can result in high cost and difficulties in cabling.

To achieve high speed while maintaining low cost, the optical transceiver can combine the CWDM and SDM technologies. More specifically, recent breakthroughs in SDM based on multi-mode fibers (MMFs) or multi-core fibers (MCFs) have made it possible to achieve a compact high-speed (1.6 GHz or beyond) optical transceiver. More specifically, communication systems that implement MMF- or MCF-based SDM have been shown to have a significantly larger capacity over a single strand of fiber than conventional WDM communication systems.

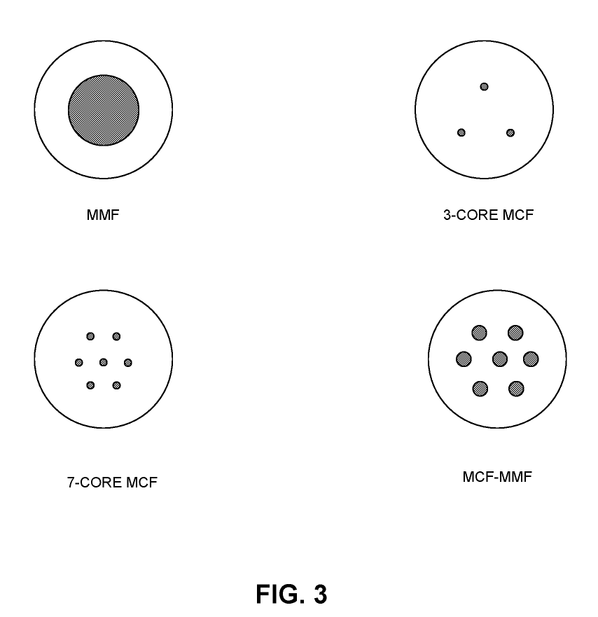

FIG. 3 shows the cross sections of different types of fibers. More specifically, FIG. 3 shows the cross sections of an MMF (top left), an MCF with three cores (top right), an MCF with seven cores (bottom left), and a hybrid MCF-MMF (bottom right). All these fibers can support more than one spatial mode, thus enabling SDM over a single strand of fiber. Other types of fibers not shown in FIG. 3, including but not limited to: MCFs with a different number of cores, few-mode fibers (FMFs), ring-core fibers (RCFs), hollow-core fibers (HCFs), can also support SDM. For simplicity, a single strand optical fiber that enables SDM can be referred to as an SDM fiber.

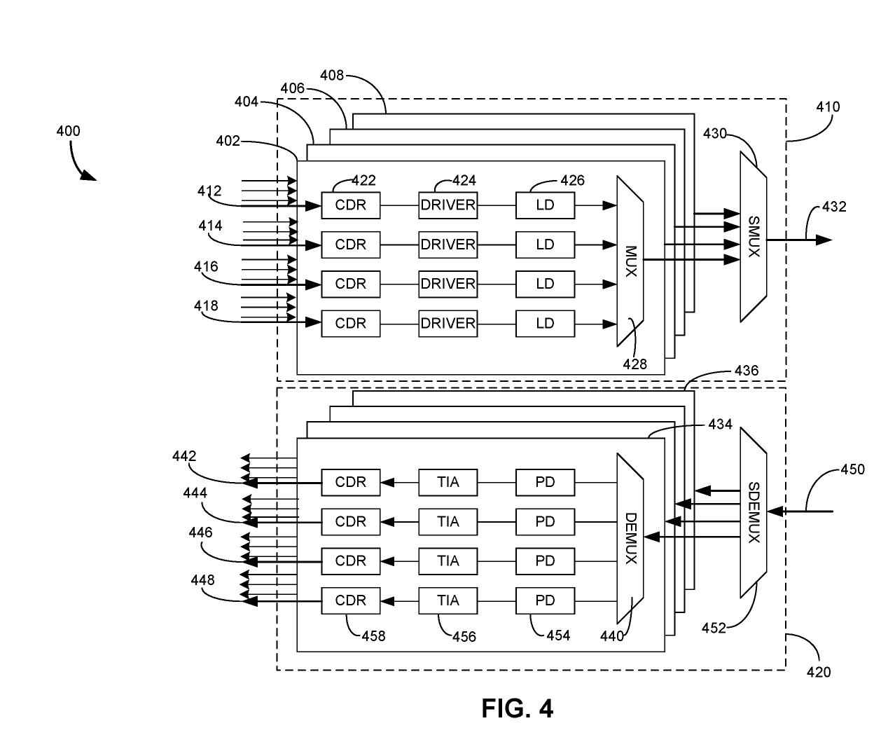

In some embodiments, SDM fibers can be used to replace SMFs in a CWDM optical transceiver to achieve an optical transceiver having a speed of 1.6 Tbps and greater. FIG. 4 shows a schematic of an exemplary high-speed optical transceiver, according to one embodiment. In FIG. 4, transceiver 400 can include a transmitter portion 410 and a receiver portion 420. Each of the transmitter and receiver can include multiple (e.g., four) SDM channels. In the drawing, the overlying planes represent the parallel SDM channels. For example, transmitter portion 410 can include SDM channels 402, 404, 406, and 408. In addition, each SDM channel can include multiple wavelength channels, such as CWDM channels. For example, SDM channel 402 can include CWDM channels 412, 414, 416, and 418, with the center wavelength of the channels being 1271 nm, 1291 nm, 1311 nm, and 1331 nm, respectively. Each wavelength channel can provide a data rate of 100 Gbps or higher, thus resulting in the overall transmitting data rate of transceiver 400 being 1.6 Tbps or higher. More specifically, one can see from FIG. 4 that there are 16 parallel electrical lanes, each sending, at a data rate of 100 Gbps or higher, electrical signals to a particular wavelength channel within a particular SDM channel. The combination of SDM and WDM (or CWDM) technologies can reduce the channel count (either the number of SDM channels or the number of WDM channels) compared with only one technology being used. For example, if only WDM is used, at least 16 100 Gbps wavelength channels would be needed to provide a total data rate of 1.6 Tbps or higher. Similarly, if only SDM is needed, at least 16 SDM channels would be needed to provide a total data rate of 1.6 Tbps or higher. Such a high channel count often requires highly precise optics or large size components.

FIG. 4 also shows that each wavelength channel can include a clock and data recovery (CDR) module, a laser driver, and a laser module. The CDR module can perform pulse shaping on the received electrical signals. For example, wavelength channel 412 can include a CDR module 422, a laser driver 424, and a laser diode (LD) module 426. In some embodiments, LD module 426 can include a directly modulated laser (DML) or an externally modulated laser (EML). More specifically, an EML can include a continuous wave (CW) laser and a modulator, such as an electro-absorption modulator or a Mach-Zehnder modulator. Compared to a DML, an EML can provide a larger bandwidth and can achieve a higher extinction ratio, thus having a better performance. The wavelengths of the laser modules can be selected according to the CWDM standard. As discussed previously, the wavelength of the laser modules can be set as 1271 nm, 1291 nm, 1311 nm, and 1331 nm.

Optical signals from the multiple wavelength channels can be combined onto a single SDM channel by an optical wavelength multiplexer. For example, optical wavelength multiplexer 428 can combine CWDM channels 412, 414, 416, and 418 to form single SDM channel 402. The output of optical wavelength multiplexer 428 can include a specially designed fiber or semiconductor-based waveguide that can support a particular SDM mode.

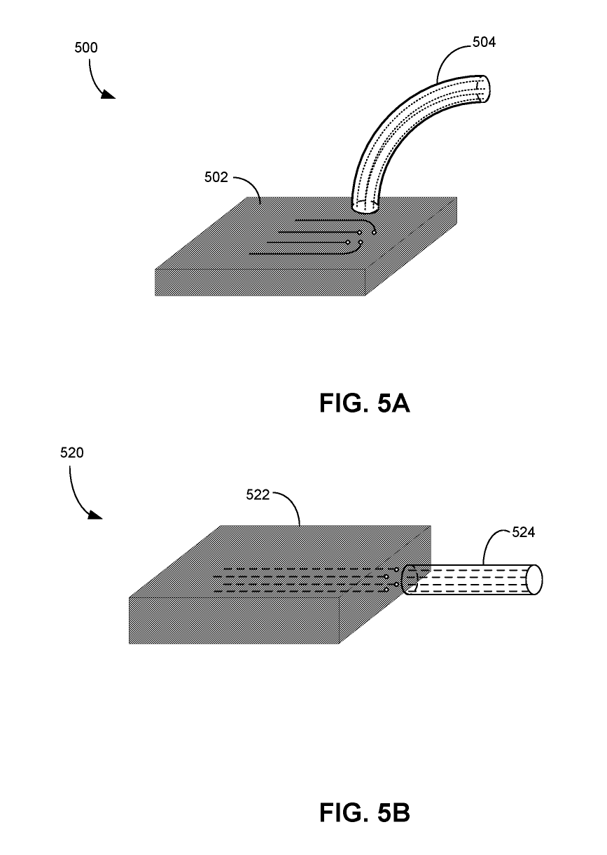

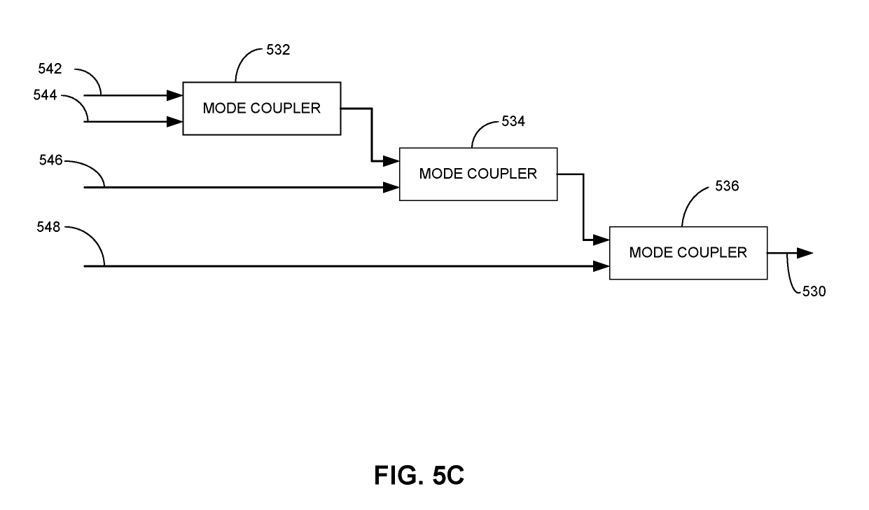

Transmitter portion 410 can also include a spatial mode multiplexer (SMUX) 430, which can combine the multiple (e.g., four) spatial modes onto a single SDM fiber. Various technologies can be used to implement the SMUX, such as surface coupling or edge coupling between a set of semiconductor waveguides and an MCF or MMF. FIG. 5A shows an exemplary surface-coupled spatial mode multiplexer, according to one embodiment. SMUX 500 can include a waveguide structure 502 and an MCF 504. Waveguide structure 502 can include multiple spatially separated waveguides, each carrying optical signals of a particular SDM channel. MCF 504 can simultaneously couple to the multiple waveguides via the surface of waveguide structure 502. MCF 504 can then couple to an MCF (not shown in FIG. 5A) external to the high-speed transceiver. A specially designed MCF coupler can be used to couple MCF 504 and the external MCF. FIG. 5B shows an exemplary edge-coupled spatial mode multiplexer, according to one embodiment. SMUX 520 can include a waveguide structure 522 and an MCF 524. Waveguide structure 522 can be a 3D waveguide structure and can include multiple spatially separated waveguides. Outputs of the waveguides are located on an edge of waveguide structure 522. Consequently, MCF 524 can simultaneously couple to the multiple waveguides via the edge of waveguide structure 522. Similar to MCF 504, MCF 524 can couple to an external MCF via a specially designed MCF coupler.

In the examples shown in FIGS. 5A and 5B, MCFs are used for SDM purposes. In practice, MMFs or MMF-MCF hybrids can also be used. Depending on the type of SDM fiber used, an appropriate type of SMUX can be used for multiplexing the multiple SDM modes onto the SDM fiber. FIG. 5C shows an exemplary multi-stage waveguide mode multiplexer, according to one embodiment. More specifically, in FIG. 5C, 2×1 mode couplers 532, 534, and 536 can combine SDM channels 542, 544, 546, and 548 onto a single MMF 530. A 2×1 mode coupler can be based on fused fiber technology. In some embodiments, each SDM channel can carry signals outputted by an optical wavelength multiplexer. To ensure a desired spatial mode on each SDM channel, a mode selector or a mode converter may be applied at the output of the optical wavelength multiplexer. In addition to using multiple 2×1 mode couplers, in some embodiments, a pot-based 4×1 mode coupler (which can be semiconductor waveguide-based or fiber-based) can be used to directly combine four SDM channels onto a single MMF.

Returning to FIG. 4, receiver portion 420 of transceiver 400 can also include multiple SDM channels (e.g., SDM channels 434 and 436), with each SDM channel supporting multiple wavelength channels. For example, SDM channel 434 can include wavelength channels 442, 444, 446, and 448. Similar to the ones in transmitter portion 410, each wavelength channel in receiver portion 420 can provide a data rate of 100 Gbps or higher, thus resulting in the overall receiving data rate of transceiver 400 being 1.6 Tbps or higher. Each wavelength channel can include a photo detector (PD) module for converting the received optical signals to electrical signals, a trans-impedance amplifier (TIA) module for amplification, and a CDR module for signal shaping. For example, wavelength channel 448 can include PD module 454, TIA module 456, and CDR module 458.

In the receiving direction, a single SDM fiber 450 can couple to a spatial mode demultiplexer (SDEMUX) 452. The structure of SDEMUX 452 can be similar to SMUX 430. The outputs of the SDEMUXs can be separately fed to the optical wavelength demultiplexers for wavelength demultiplexing. For example, a demuxed output of SDEMUX 452 can be fed to optical wavelength demultiplexer 440, which produces inputs to wavelength channels 442 through 448.

In some embodiments, the wavelength channels in both transmitter portion 410 and receiver portion 420 of transceiver 400 can be CWDM channels, meaning that they have a channel spacing of at least 20 nm. This large channel spacing makes it possible to use low-cost un-cooled lasers as light sources, thus significantly reducing the overall cost of the datacenter network. For example, LD module 426 can include a low-cost laser operating without temperature control, and may have a wavelength tolerance of ±6 nm.

Most of the transceiver components, such as the CDR modules, the lasers, the PDs, etc., can be highly integrated. In some embodiments, using new technologies, such as silicon photonics, the electrical components (e.g., CDRs and laser drivers) and the optical components (e.g., the lasers and multiplexers) can be integrated onto the same substrate. The usage of a single SDM fiber to accommodate the multiple SDM channels can enable a highly compact design of the high-speed transceiver. In some embodiments, the optical transceiver having a speed of 1.6 Tbps or higher can conform to a standard form factor, such as small-form factor pluggable (SFP), SFP⁺, XENPAK, etc. These transceivers with the standard form factors can be compatible to many existing switches or routers in datacenters.

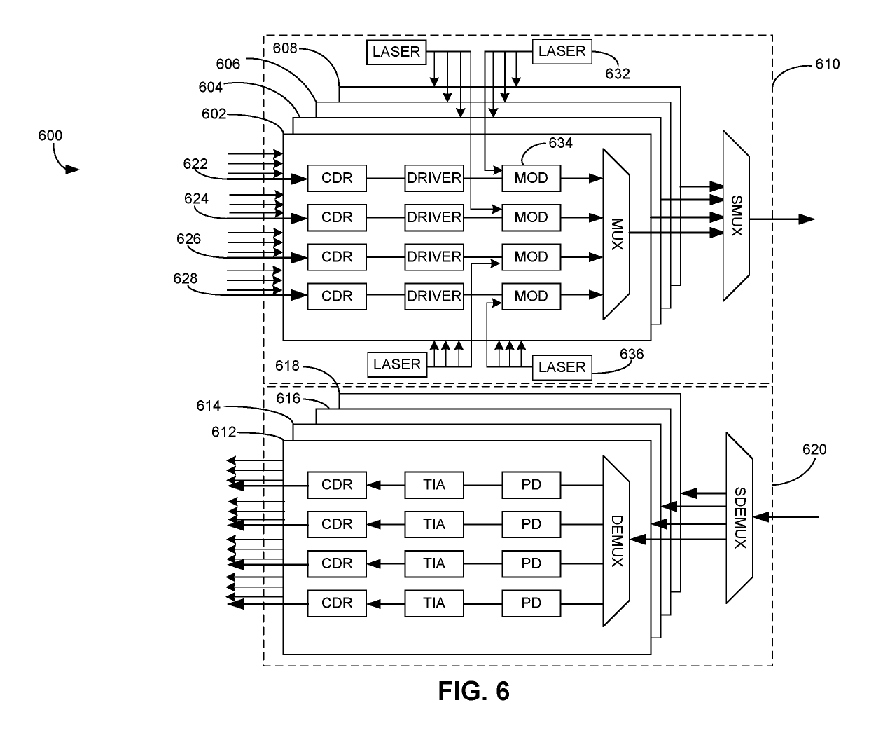

FIG. 6 shows a schematic of an alternative exemplary high-speed optical transceiver, according to one embodiment. Similar to transceiver 400, transceiver 600 can include a transmitter portion 610 and a receiver portion 620, with each portion including multiple SDM channels. For example, transceiver portion 610 can include SDM channels 602, 604, 606, and 608; and receiver portion 620 can include SDM channels 612, 614, 616, and 618. Moreover, each SDM channel can include multiple wavelength channels. For example, SDM channel 602 can include wavelength channels 622, 624, 626, and 628.

Different from the wavelength channels shown in FIG. 4, a wavelength channel in transmitter portion 610 does not include its own dedicated modulated laser. Instead, multiple wavelength channels belonging to different SDM channels but having a similar wavelength can share a continuous wave (CW) laser. More specifically, light from a CW laser having a particular wavelength (e.g., 1271 nm) can be fed to multiple external modulators (e.g., electro-absorption modulators or Mach-Zehnder modulators), each modulating optical signals for a corresponding optical channel (or optical lane) within a particular SDM. For example, CW laser 632 can be shared by wavelength channel 622 within SDM channel 602 and other similar wavelength channels within SDM channels 604, 606, and 608. More specifically, light from CW laser 632 can be sent to modulator 634 belonging to wavelength channel 622 and other modulators (blocked from view in FIG. 6) belonging to other corresponding wavelength channels. Similarly, CW laser 636 can be shared by wavelength channel 628 within SDM channel 602 and other similar wavelength channels within SDM channels 604, 606, and 608. Receiver portion 620 can be similar to receiver portion 420 shown in FIG. 4.

In the example shown in FIG. 6, there are four lasers, each shared among SDM channels 622-628. In some embodiments, the wavelengths of the four lasers are selected according to CWDM standard. For example, the wavelength of the four lasers can be 1271 nm, 1291 nm, 1311 nm, and 1331 nm, respectively. The number of CW lasers can be different than the example shown in FIG. 6. In some embodiments, up to eight CW lasers can be used in transceiver 600, with the eight CW lasers divided into four wavelength groups. In other words, the eight CW lasers can be divided into four pairs, with each pair of lasers having the same wavelength. In such a scenario, each CW laser can be shared by two optical lanes or channels from two different SDM channels. It is also possible to use 16 CW lasers.

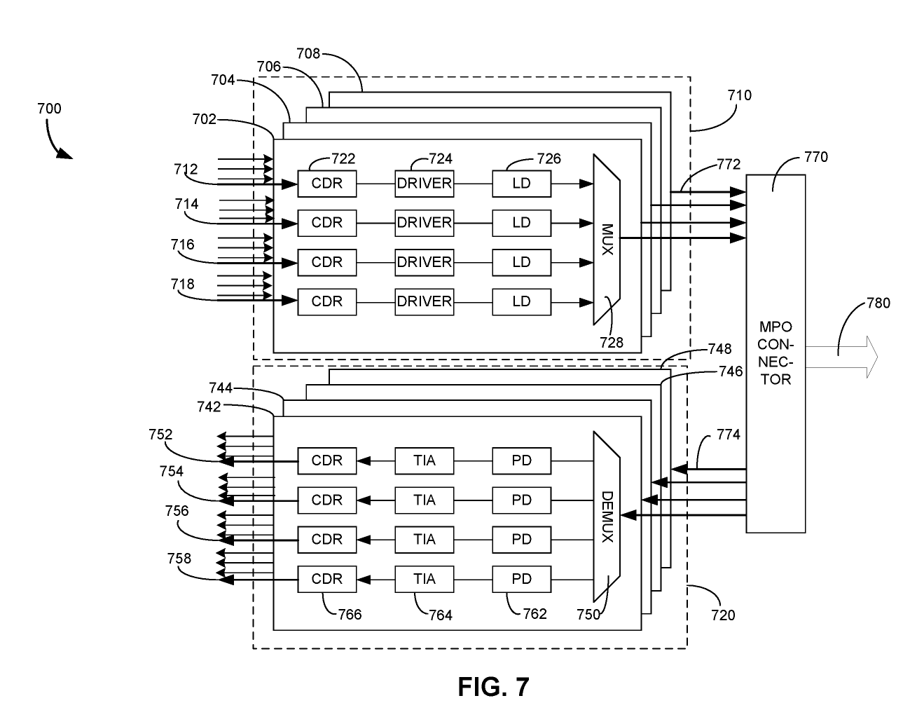

Although MCF- or MMF-based SDM can enable a more compact device size, achieving spatial multiplexing and demultiplexing may not be easy. In some embodiments, instead of the fiber or waveguide modes, SDM can be realized via the implementation of multiple single mode fibers (SMFs). FIG. 7 shows a schematic of a high-speed optical transceiver based on multiple fibers, according to one embodiment. In FIG. 7, transceiver 700 can include four fiber channels (one channel per fiber) in each direction. In the drawing, the overlying planes represent parallel fibers. For example, in the transmitting direction (i.e., transmitter portion 710), transceiver 700 can include fiber channels 702, 704, 706, and 708. In addition, each fiber channel can include four wavelength channels. For example, fiber channel 702 can include wavelength channels 712, 714, 716, and 718. Each wavelength channel can provide a data rate of 100 Gbps or higher, thus resulting in the overall transmitting data rate of transceiver 700 being 1.6 Tbps or higher. In some embodiments, wavelength channels 712-718 can be CWDM channels. FIG. 7 also shows that each wavelength channel in the transmitting direction can include a clock and data recovery (CDR) module, a laser driver, and a laser module. For example, wavelength channel 712 can include a CDR module 722, a laser driver 724, and a laser diode (LD) module 726.

Similar to wavelength channels shown in FIG. 4, the laser module in each of the wavelength channels can include a DML or an EML. The multiple wavelength channels within a fiber channel can be combined onto a single fiber by an optical wavelength multiplexer. For example, fiber channel 702 can include an optical wavelength multiplexer 728, which allows optical signals from the four wavelength channels to be combined onto a single fiber. In general, each fiber channel has a single fiber input and a single fiber output. In some embodiments, the input and output fibers can both be SMFs.

Similarly, in the receiving direction (i.e., receiver portion 720), transceiver 700 can include fiber channels 742, 744, 746, and 748, with each fiber channel including four wavelength channels. For example, fiber channel 742 can include wavelength channels 752, 754, 756, and 758, with each wavelength channel running a data rate of 100 Gbps or higher. The overall receiving data rate of transceiver 700 can be 1.6 Tbps or higher. Fiber channel 742 can also include an optical wavelength demultiplexer 750, which demultiplexes received optical signals to different wavelength channels.

Similar to the receiving wavelength channel shown in FIG. 4, each receiving wavelength channel in transceiver 700 can include a photo detector (PD) module for converting the demultiplexed optical signals to electrical signals, a trans-impedance amplifier (TIA) module for amplifying the electrical signals, and a CDR module for pulse shaping. For example, fiber channel 758 can include PD module 762, TIA module 764, and CDR module 766.

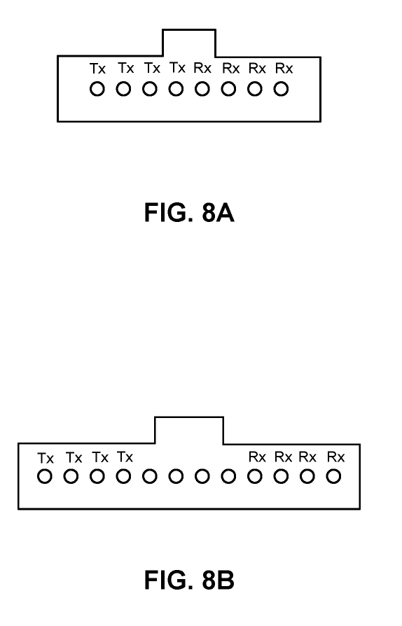

As one can see from FIG. 7, there are multiple (e.g., four) fibers coupled to transmitting portion 710 (e.g., transmitting fiber 772) and multiple (e.g., four) fibers coupled to receiver portion 720 (e.g., receiving fiber 774). In a datacenter environment, these fibers can be used to couple one datacenter component (e.g., a server, switch, or router) with a different data center component (e.g., a server, switch, or router). To enable plug and play, in some embodiments, transceiver 700 can also include a MPO (Multiple-Fiber Push-on/Pull-off) connector 770 coupled to both the transmitting fibers and the receiving fibers. MPO connector 770 can be coupled to an external multi-fiber optical cable 780, which can be an MPO trunk cable or a fan-out cable. The MPO trunk cable can include MPO connectors on either end of an eight- or twelve-fiber ribbon cable. The MPO fan-out cable can include an MPO connector on one end while the other end of the cable can have a variety of standard optical fiber interfaces, such as LC or SC connectors. In some embodiments, MPO connector 770 can include an eight-fiber connector (e.g., MPO-8) or a twelve-fiber connector (e.g., MPO-12). FIG. 8A shows the layout of an MPO-8 connector. FIG. 8B shows the layout of an MPO-12 connector.

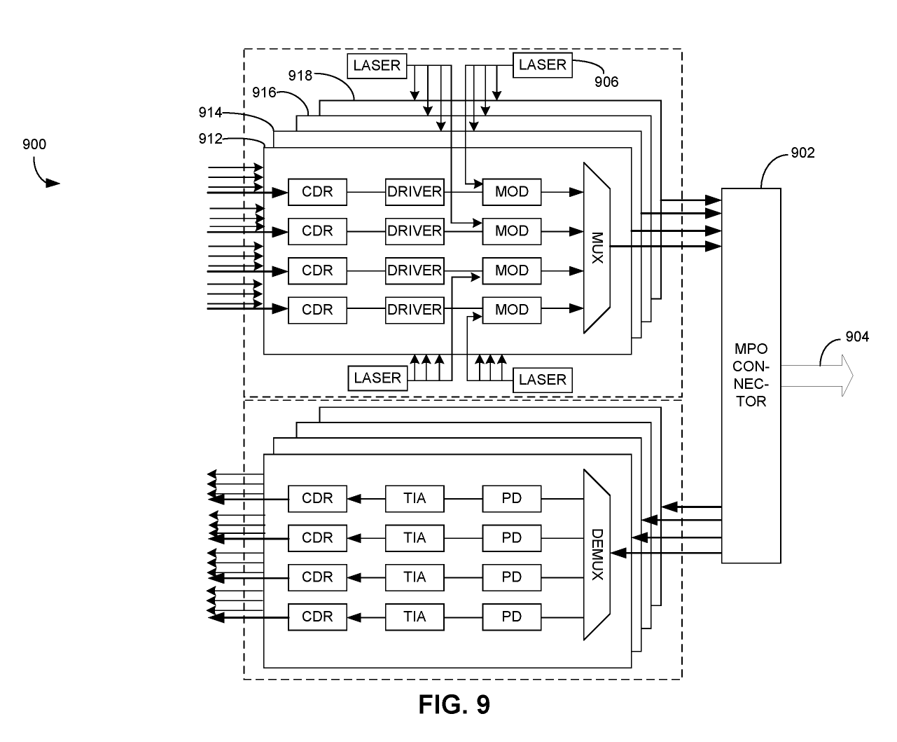

FIG. 9 shows a schematic of a high-speed optical transceiver based on multiple fibers, according to one embodiment. The electrical input/output interface and the optical input/output interface of high-speed optical transceiver 900 can be similar to those of high-speed optical transceiver 700 shown in FIG. 7. More specifically, the electrical input or output interface can include 16 parallel lanes, each running at a speed of 100 Gbps, and the optical input/output interface can include an MPO connector 902 coupled to an MPO cable 904. MPO connector 902 and MPO cable 904 can be similar to MPO connector 770 and MPO cable 780, respectively, shown in FIG. 7.

Unlike high-speed optical transceiver 700 that uses dedicated laser module for each wavelength channel, high-speed optical transceiver 900 allows multiple wavelength channels to share the same laser source in a way similar to high-speed optical transceiver 600 shown in FIG. 6. More specifically, a CW laser (e.g., CW laser 906) can input light to multiple external modulators (e.g., electro-absorption modulators or Mach-Zehnder modulators), each modulating optical signals for a corresponding optical channel (or optical lane) within a particular SDM. In the example shown in FIG. 9, four CW lasers with four different wavelengths are used, each shared among four SDM channels (e.g., SDM channels 912-918). The wavelengths of the four CW lasers can be selected according to the CWDM standard.

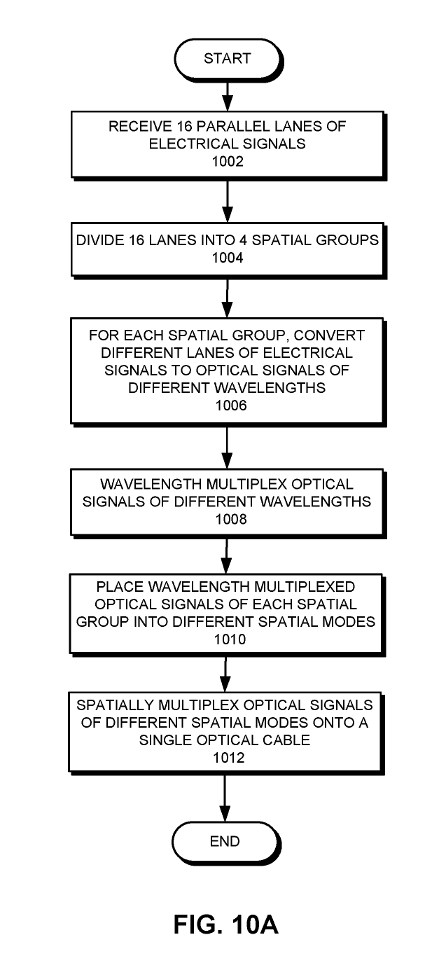

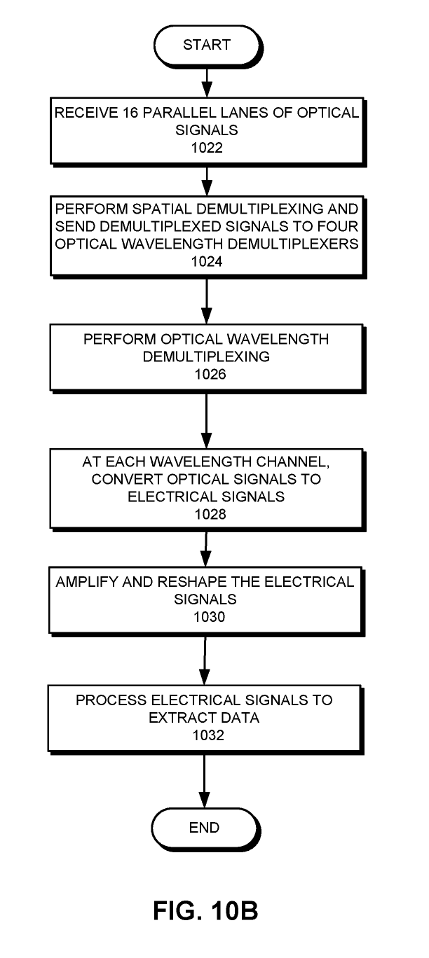

FIG. 10A presents a flow chart illustrating an exemplary process for transmitting data at a speed of at least 1.6 Tbps, according to one embodiment. During operation, at least 16 parallel lanes of electrical signals representing to-be-transmitted data can be sent to the electrical interface of an optical transmitter (operation 1002). Each of the 16 parallel lanes of electrical signals can have a data rate of 100 Gbps. The 16 lanes of electrical signals can be divided into four spatial groups, with each spatial group including four lanes (operation 1004). For each spatial group, the four lanes of electrical signals can be respectively converted to optical signals of four different wavelengths (operation 1006). In some embodiments, the four wavelengths are selected based on CWDM standards. The optical signals of different wavelengths from the same spatial group can then be combined by an optical wavelength multiplexer (operation 1008). The combined optical signals from a particular spatial group can be placed into a particular spatial mode to distinguish them from optical signals from other spatial groups (operation 1010). In some embodiments, the outputs of the optical wavelength multiplexers can include spatially separated fibers or waveguides that support different transmission modes. Subsequently, optical signals from the four spatial groups can be combined spatially onto an optical cable (operation 1012). For example, they can be combined via an MPO connector onto a single MPO cable. Alternatively, the optical signals from the different spatial groups can have different fiber transmission modes and can be combined via a SDM multiplexer onto a single SDM fiber, which can be an MCF or an MMF.

FIG. 10B presents a flow chart illustrating an exemplary process for receiving data at a speed of at least 1.6 Tbps, according to one embodiment. During operation, a high-speed optical receiver receives at least 16 parallel lanes of optical signals carrying data at speed of at least 1.6 Tbps (operation 1022). Each of the 16 parallel lanes of optical signals can have a data rate of 100 Gbps. A particular optical lane can be separated from other optical lanes either in spatial domain or wavelength domain. The received optical signals can be spatially separated (either by an MPO connector or a spatial mode demultiplexer) and sent to four different optical wavelength demultiplexers (operation 1024). Each optical wavelength multiplexer can then demultiplex the received signals to four wavelength channels (operation 1026). A photo detector in each wavelength channel can then convert received optical signals to electrical signals (operation 1028). The electrical signals can then be amplified and reshaped (operation 1030). The total 16 parallel lanes of electric signals can then be sent for further processing to extract data (operation 1032).

In general, embodiments of the present invention provide an optical transceiver that can achieve a transmitting and receiving speed of 1.6 Tbps or greater by combining CWDM technology and SDM technology. Using four SDM channels and four CWDM channels per SDM channel, the total number of parallel optical lanes can reach 16, making it possible to run each optical lane at a moderate speed of 100 Gbps. This moderate speed significantly reduces the bandwidth requirement for electrical and optical components used in the transceiver. For example, if pulse amplitude modulation (e.g., PAM-4) is used for data modulation, the bandwidth requirement for each optical lane only needs to be larger than 30 GHz. Moreover, due to the large channel spacing among CWDM channels, low-cost un-cooled lasers can be used. The multiple SDM channels can be realized through multiple fibers or multiple transmission modes in a single MCF or MMF. The total number of fibers is much less compared to the scenario where multiple fibers is the only multiplexing mechanism, thus significantly reducing the total cost of fibers in a datacenter.

Note that in addition to the examples shown in FIGS. 4, 6-7, and 9, the high-speed optical transceiver can have different configurations. For example, instead of using a single SDM fiber as an output or input, in some embodiments, it is also possible to have more than one SDM fiber. More specifically, each SDM fiber can accommodate two different spatial modes, and the transceiver can use two separate SDM fibers to accommodate four spatial modes. Moreover, the high-speed optical transceiver can double the number of SDM fibers, hence doubling the channel count. If each channel runs the same data rate of 100 Gbps, the transceiver can have a data rate of 3.2 Tbps. Alternatively, each channel can run a lower data rate, such as 50 Gbps, thus further relaxing the bandwidth requirement on the electrical and optical components while maintaining an overall data rate of 1.6 Tbps. Significant benefits (e.g., faster data rate, lower-cost due to reduced fiber count or relaxed bandwidth requirement, and more compact device size) can be achieved as long as the CWDM technology is combined with the SDM technology.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

1. An optical transceiver, comprising:
a transmitter and a receiver, wherein each of the transmitter and receiver comprises:
a multi-mode fiber (MMF) carrying a plurality of space-division multiplexing (SDM) channels configured to transmit or receive spatially
separated optical signals; and
at least one mode coupler or de-coupler for coupling or de-coupling the plurality of SDM channels;
wherein a respective SDM channel comprises:
a plurality of wavelength channels; and
an optical wavelength multiplexer or demultiplexer configured to multiplex or demultiplex optical signals to or from the plurality of wavelength channels.

2. (canceled)

3. (canceled)

4. (canceled)

5. (canceled)

6. The optical transceiver of claim 1, wherein each of the transmitter or receiver comprises at least four SDM channels, and wherein each SDM channel comprises at least four wavelength channels.

7. The optical transceiver of claim 6, wherein each wavelength channel has a data rate of at least 100 gigabit per second (Gbps), thereby resulting in the optical transceiver having a data rate of at least 1.6 terabit per second (Tbps).

8. An optical transmitter, comprising:
a multi-mode fiber (MMF) carrying a plurality of space-division multiplexing (SDM) channels configured to transmit spatially separated optical signals; and
at least one mode coupler for coupling the plurality of SDM channels;
wherein a respective SDM channel comprises:
a plurality of wavelength channels; and
an optical wavelength multiplexer configured to combine optical signals from the plurality of wavelength channels.

9. (canceled)

10. (canceled)

11. (canceled)

12. The optical transmitter of claim 8, wherein the transmitter comprises at least four SDM channels, and wherein each SDM channel comprises at least four wavelength channels.

13. The optical transmitter of claim 12, wherein each wavelength channel has a data rate of at least 100 gigabit per second (Gbps), thereby resulting in a transmitting data rate of at least 1.6 terabit per second (Tbps).

14. An optical receiver, comprising:
a multi-mode fiber (MMF) carrying a plurality of space-division multiplexing (SDM) channels configured to receive spatially separated optical signals; and
at least one mode de-coupler for de-coupling the plurality of SDM channels,
wherein a respective SDM channel comprises:
a plurality of wavelength channels; and
an optical wavelength demultiplexer configured to demultiplex optical signals to the plurality of wavelength channels.

15. (canceled)

16. (canceled)

17. (canceled)

18. The optical receiver of claim 14, wherein the receiver comprises at least four SDM channels, and wherein each SDM channel comprises at least four wavelength channels.

19. The optical receiver of claim 18, wherein each wavelength channel has a data rate of at least 100 gigabit per second (Gbps), thereby resulting in a receiving data rate of at least 1.6 terabit per second (Tbps).

20. The optical transceiver of claim 1, wherein the plurality of wavelength channels have a channel spacing of at least 20 nm.

21. The optical transceiver of claim 1, wherein each of the transmitter further comprises a clock and data recovery (CDR) module, a laser driver, and a laser module, and
wherein the CDR module, the laser driver and the laser module are integrated onto a same substrate.

22. The optical transceiver of claim 21, wherein the optical transceiver is conformed to a standard form factor.

23. The optical transmitter of claim 8, wherein the plurality of wavelength channels have a channel spacing of at least 20 nm.

24. The optical transmitter of claim 8, further comprising a clock and data recovery (CDR) module, a laser driver, and a laser module,
wherein the CDR module, the laser driver, and the laser module are integrated onto a same substrate.

25. The optical transmitter of claim 24, wherein the optical transmitter conformed to a standard form factor.

26. The optical receiver of claim 14, wherein the plurality of wavelength channels have a channel spacing of at least 20 nm.

27. The optical receiver of claim 14, further comprising a clock and data recovery (CDR) module, an amplifier, and a photo detector module,
wherein the CDR module, the amplifier, and the photo detector module are integrated onto a same substrate.

28. The optical receiver of claim 27, wherein the optical receiver is conformed to a standard form factor.
